(19) United States
(12) Patent Application Publication
(10) Pub. No.: US 2011/0090590 A1
(43) Pub. Date: Apr. 21, 2011

(54) HEAD POSITION CONTROL DEVICE, MAGNETIC RECORDING EVALUATION APPARATUS, AND HEAD POSITION CONTROL METHOD

(75) Inventors: Yukio YAMAMOTO, Toride (JP); Yasuhiro MATSUDA, Ishioka (JP); Toshinori SUGIYAMA, Ninomiya (JP); Yoshihiro SAKURAI, Hadano (JP); Kunihito HIGA, Isehara (JP)

(73) Assignee: HITACHI HIGH-TECHNOLOGIES CORPORATION

(21) Appl. No.: 12/906,687

(22) Filed: Oct. 18, 2010

(30) Foreign Application Priority Data
Oct. 21, 2009 (JP) 2009-242094

(51) Int. Cl. G11B 5/596

(52) U.S. Cl. 360/77.05; G9B/5.216

(57) ABSTRACT

At time to start learning feed-forward control and under the status that servo-drive is not put in execution, a positioning error of repeatable runout is detected by means of a positioning error of repeatable runout operation section and on the basis of a value of the positioning error of repeatable runout, a drive pattern and drive interval of idling are determined by means of a feed-forward data operation section. The drive pattern is stored in a feed-forward data memory and is outputted as feed-forward data in synchronism with the rotation of a spindle during drive interval, thus performing idling of a fine-movement actuator. After the idling has ended, control initiation sequence is resumed to carry out learning of feed-forward control.

### BACKGROUND OF THE INVENTION

The present invention relates to an apparatus for controlling a head position in relation to a magnetic recording medium formed with servo-patterns, a magnetic recording assessment apparatus for assessing a magnetic recording medium or a magnetic head by controlling the position of the magnetic head with the help of the head position control apparatus and a head position control method as well.

Some schemes have been known for a technique for achieving high-density recoding in a magnetic disk device. One of them is a discrete track type magnetic disk (hereinafter referred to as DTM type disk) in which a groove is formed between adjacent ones of a plurality of tracks formed concentrically and so individual tracks are separated magnetically with a view to improving magnetic recording characteristics and another is a bit pattern media (BPM) type disk according to which an array of magnetic dots is provided and one bit is stored in one dot.

These types of disk are different from each other in recording scheme but they have a non-magnetic region between adjacent tracks and therefore, for extraction of signals from a disk of high-density recording, they cannot dispense with a highly accurate positioning technique. A positioning technique according to the present invention can be applicable to any of the above schemes but the following description will be given particularly by way of the DTM type disk.

In the DTM type disk, servo-information indicative of accurate positions of the tracks and accurate positions on the DTM type disk as well is formed on the disk in the phase of fabrication and accordingly, generation of eccentricity of the track center with the rotation center of spindle is inevitable owing to not only errors during disk fabrication but also alignment errors. The eccentricity leads to a primary positioning error of repeatable runout when the head is positioned at a track on the disk and besides, deformation during disk fabrication and distortion at the time of mounting the disk to the spindle give rise to higher-order positioning error of repeatable runout.

As will be seen from the above, the individual tracks are separated magnetically from each other in the DTM type disk and the head is always required to be positioned accurately on a track and therefore, needs to be positioned accurately in relation to servo-information. In the ordinary feedback servo, however, the servo-band is limited and there is a high possibility that correction of a positioning error of repeatable runout component including the eccentricity will become insufficient.

The eccentricity taking place at the time the DTM type disk is mounted to the apparatus will possibly amount up to a maximum of several 10 μm (micrometers) when a eccentricity generated during fabrication is taken into account. In order for magnetic recording and reproduction to be performed with high accuracies under these conditions, the accuracy of head positioning is desired to meet suppressing the rotation primary component of a positioning error of repeatable runout due to the eccentricity to, for example, less than 1 nm (nanometer). In the general feedback servo, reducing the rotation primary component of positioning error of repeatable runout to less than 1/several ten thousands is very difficult to achieve. It is also difficult to deal with higher-order positioning error of repeatable runout having higher frequencies than the servo-band.

As a countermeasure against the above problems, a method has been proposed as disclosed in, for example, Japanese Patent No. 3344495, according to which an amount of eccentricity of a magnetic disk is detected from a read signal from the magnetic disk and a misalignment control quantity corresponding to the misalignment amount is added to a tracking control quantity so as to perform position control of the magnetic head. In this case, by performing, in addition to the feedback servo, a feed-forward control for adding the predetermined control quantity, the rotation primary component of positioning error of repeatable runout due to the eccentricity can be reduced significantly and the higher-order positioning error of repeatable runout having higher frequencies than the servo-band can be corrected.

### SUMMARY OF THE INVENTION

Incidentally, the majority of magnetic recording assessment apparatus for assessing a magnetic head and a magnetic disk uses a piezo-actuator adapted for head positioning with a view to performing highly accurate positioning. For the feed-forward control quantity, a value obtained by multiplying the positioning error of repeatable runout component by an inverse model of a control objective is generally used but the piezo-actuator has nonlinear characteristic such as hysteresis characteristics and is difficult to model, so that calibration or matching of feed-forward control quantities through learning such as repetitive control is indispensable.

When the piezo-actuator is driven continuously at a large amplitude, however, heat generated causes the temperature dependent characteristics of piezoe-effect and circuit characteristics of a piezo-driver to vary, followed by variations in characteristics of the control objective, and as a result, the head trace based on the feed-forward control deviates. The variation in characteristics of the piezo-actuator is considered to exceed several % and the change quantity is maximized immediately after drive start in correspondence with the change status of heat generation and thereafter decreases gradually. Under the circumstances, learning of normal feed-forward control is carried out at the time of drive start and therefore, at the time that assessment of magnetic recording is actually performed, the error in feed-forward control increases and disadvantageously, the assessment is affected adversely.

An object of the present invention is to provide a magnetic head position control device which can perform stable feed-forward control by avoiding the influence of variations in characteristics of a piezo-actuator due to generated heat and can control a magnetic head to enable it to follow a track on the magnetic disk highly accurately.

Another object of the invention is to provide a magnetic recording evaluation apparatus incorporating the magnetic head position control device.

Still another object of the invention is to provide a magnetic head control method.

To accomplish the above objects, a typical head position control device of the present invention comprises a rotary drive mechanism for rotating a magnetic recording medium formed in advance with servo-patterns, a magnetic head for recording and reproducing a signal to and from the magnetic recording medium, an actuator capable of moving the magnetic head on the magnetic recording medium in at least radial direction thereof, a servo-decoding unit for detecting from a servo-pattern reproduction signal of the magnetic head a relative position of the magnetic head to the magnetic recording medium, a servo-drive unit responsive to the position signal from the servo-decoding unit to generate a servo-drive signal adapted to control positioning of the actuator, a pattern drive unit for generating a pattern drive signal adapted to drive the actuator in accordance with a predetermined drive pattern, and a control unit for controlling operation of the respective components, wherein the control unit provides an idling interval during at least one of a period preceding a control initiation sequence for the servo-drive unit to start controlling the actuator and a period being on the midway of the control initiation sequence, the pattern drive unit generates a pattern drive signal adapted to drive the actuator in accordance with the predetermined drive pattern during the idling interval, the servo drive unit stops the control initiation sequence during the idling interval and starts or resumes the control initiation sequence after the idling interval has ended, and the actuator responds to a pattern drive signal from the pattern drive unit and a servo-drive signal from the servo-drive unit to control the position of the magnetic head.

The head position control device may further comprise a rotation synchronous signal detection unit for detecting from the position signal delivered out of the servo-decoding unit a rotation synchronous signal in synchronism with the rotation of the rotary drive mechanism, wherein the pattern drive unit may determine a length of the idling interval and a drive pattern on the basis of the rotation synchronous signal from the rotation synchronous signal detection unit, and the control unit may control the pattern drive unit and idling operation of the servo-drive unit on the basis of the idling interval length determined by the pattern drive unit.

The head position control apparatus may further comprise a drive history operation unit for calculating a drive history signal of the actuator from the drive signal thereof, wherein the pattern drive unit may determine a length of the idling interval and a drive pattern on the basis of the drive history signal from the drive history operation unit, and the control unit may control the pattern drive unit and idling operation of the servo-drive unit on the basis of the idling interval length determined by the pattern drive unit.

The head position control apparatus may include in the control initiation sequence an operation for learning the feed-forward control.

Preferably, in the head position control apparatus, the actuator may be a piezo-actuator.

To accomplish the above objects, a typical magnetic recording assessment apparatus of the present invention comprises a rotary drive mechanism for rotating a magnetic recording medium formed in advance with servo-patterns, a magnetic head for recording and reading a signal to and from the magnetic recording medium, an actuator capable of moving the magnetic head on the magnetic recording medium in at least radial direction thereof, a servo-decoding unit for detecting from a servo-pattern read signal of the magnetic head a relative position of the magnetic head to the magnetic recording medium, a servo-drive unit responsive to the position signal from the servo-decoding unit to generate a servo-drive signal adapted to control positioning of the actuator, a pattern drive unit for generating a pattern drive signal adapted to drive the actuator in accordance with a predetermined drive pattern, a control unit for controlling operation of the respective components, and an assessment unit for recording a specified pattern on the magnetic recording medium with the help of the magnetic head and for assessing magnetic recording characteristics from a reproduction signal of the specified pattern, wherein the control unit provides an idling interval during at least one of a period preceding a control initiation sequence for the servo-drive unit to start controlling the actuator and a period being on the midway of the control initiation sequence, the pattern drive unit generates a pattern drive signal adapted to drive the actuator in accordance with the predetermined drive pattern during the idling interval, the servo drive unit stops the control initiation sequence during the idling interval and starts or resumes the control initiation sequence after the idling interval has ended, the actuator responds to a pattern drive signal from the pattern drive unit and a servo-drive signal from the servo-drive unit to control the position of the magnetic head, and the evaluation unit records the specified pattern on the magnetic recording medium under the status that the magnetic head position control is put in execution and assesses the magnetic recording characteristics from the read signal of the specified pattern.

The magnetic recording evaluation apparatus may further comprise a rotation synchronous signal detection unit for detecting from the position signal delivered out of the servo-decoding unit a rotation synchronous signal in synchronism with the rotation of the rotary drive mechanism, wherein the pattern drive unit may determine a length of the idling interval and a drive pattern on the basis of the rotation synchronous signal from the rotation synchronous signal detection unit, and the control unit may control the pattern drive unit and idling operation of the servo-drive unit on the basis of the idling interval length determined by the pattern drive unit.

The magnetic recording evaluation apparatus may further comprise a drive history operation unit for calculating a drive history signal of the actuator from the drive signal thereof, wherein the pattern drive unit may determine a length of the idling interval and a drive pattern on the basis of the drive history signal from the drive history operation unit, and the control unit may control the pattern drive unit and idling operation of the servo-drive unit on the basis of the idling interval length determined by the pattern drive unit.

The magnetic recording evaluation apparatus may include in the control initiation sequence an operation for learning the feed-forward control.

Preferably, in the magnetic recording evaluation apparatus, the actuator may be a piezo-actuator.

To accomplish the above objects, a typical head position control method of the present invention incorporates a rotary drive mechanism for rotating a magnetic recording medium formed in advance with servo-patterns, a magnetic head for recording and reading a signal to and from the magnetic recording medium, an actuator capable of moving the magnetic head on the magnetic recording medium in at least radial direction thereof, a servo-decoding unit for detecting from a servo-pattern read signal of the magnetic head a relative position of the magnetic head to the magnetic recording medium, a servo-drive unit responsive to the position signal from the servo-decoding unit to generate a servo-drive signal adapted to control positioning of the actuator, a pattern drive unit for generating a pattern drive signal adapted to drive the actuator in accordance with a predetermined drive pattern, and a control unit for controlling operation of the respective components, wherein the method comprises driving the actuator in accordance with the predetermined drive pattern, subsequently carrying out operation for learning the feed-forward control and thereafter, causing the servo-drive unit to start the operation for positioning the magnetic head.

To accomplish the above objects, a typical head position control method of the present invention incorporates a rotary drive mechanism for rotating a magnetic recording medium formed in advance with servo-patterns, a magnetic head for recording and reproducing a signal to and from the magnetic recording medium, a piezo-actuator capable of moving the magnetic head on the magnetic recording medium in at least radial direction thereof, wherein the method comprises going through a process of heat generation due to idling of the piezo-actuator before starting the magnetic head positioning operation and thereafter, starting the magnetic head positioning operation.

Preferably, the head position control method may determine the idling pattern and idling interval of the piezo-actuator in accordance with a positioning error of repeatable runout signal.

Also preferably, the head position control method may change the idling pattern and idling interval of the piezo-actuator in accordance with a drive history.

According to the present invention, the idling interval is provided before or on the midway of the control initiation sequence, put-down of variations in characteristics due to heat generation in the piezo-actuator or the like is awaited and learning of the feed-forward control or the like is carried out when the characteristics have become stable, thus ensuring that the positioning error can be reduced and the magnetic head is allowed to accurately follow a track thereon.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram illustrating the overall construction of an apparatus of the invention.

FIG. 2 is a diagram showing a TDM type disk 1 as viewed from above.

FIG. 3 is a sectional diagram showing the DTM type disk 1 taken on line A-A in FIG. 2.

FIG. 4 is a flowchart showing an example of procedures of a control initiation sequence added with an idling operation.

FIG. 5 is a waveform diagram showing an example of an idling drive pattern.

FIG. 6 is a graph showing an example of the relation between the amplitude of positioning error of repeatable runout signal 106 and the idling drive time.

FIG. 7 is a waveform diagram showing an example of an idling drive pattern for accelerating heating.

FIG. 8 is a block diagram showing another example of the construction of a magnetic recording assessment apparatus.

FIG. 9 is a graph showing an example of the relation between the amplitude of positioning error of repeatable runout signal 106 and the idling drive time in FIG. 8.

FIG. 10 is a flowchart showing an idling executed during idling interval in the FIG. 8 apparatus.

FIG. 11 is a waveform diagram showing an example of drive pattern of an idling executed during idling interval in the FIG. 8 apparatus.

### DESCRIPTION OF THE EMBODIMENTS

The present invention will now be described in greater detail by way of example with reference to the accompanying drawings.

### Embodiment

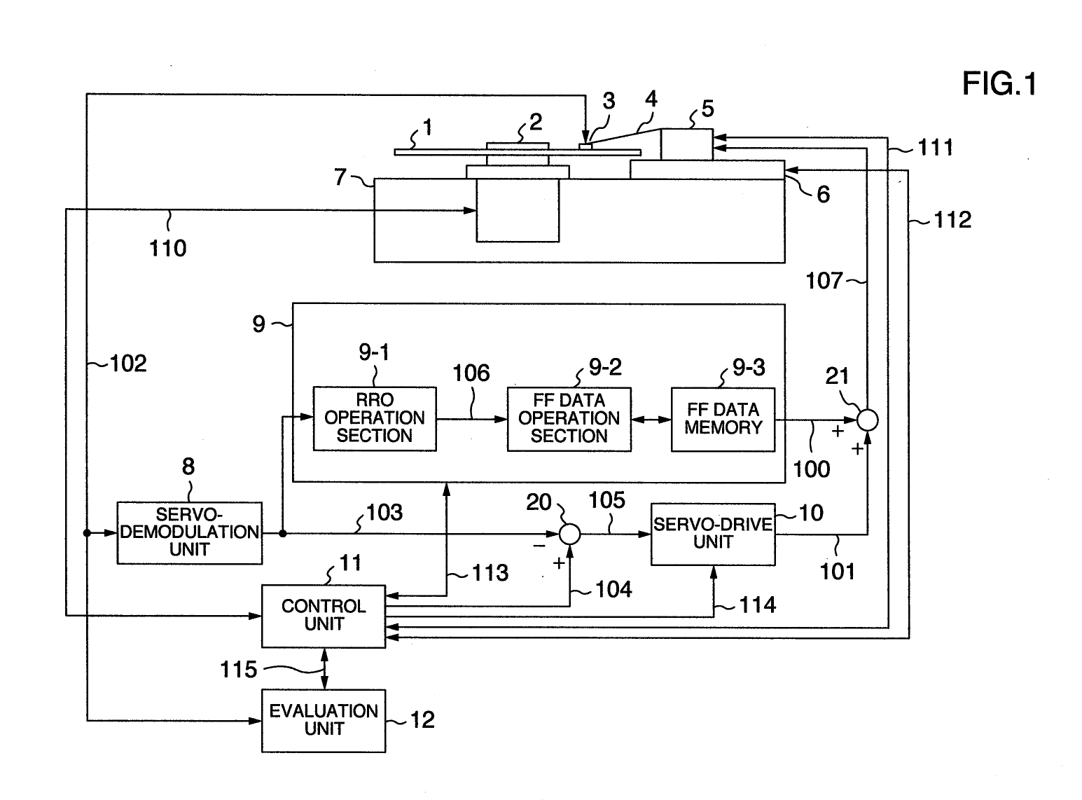

Referring to FIG. 1, there is illustrated the overall construction of an apparatus of the present invention. In the apparatus shown in FIG. 1, a drive mechanism system of DTM type disk 1 includes a spindle (rotary drive mechanism) 2, a magnetic head 3, a suspension 4, a fine-movement actuator 5, a rough-movement stage 6 and a surface plate 7.

Then, a control circuit system of the present apparatus includes a servo-decoding unit 8, a feed-forward drive unit 9, a servo-drive unit 10, a control unit 11 and an evaluation unit 12.

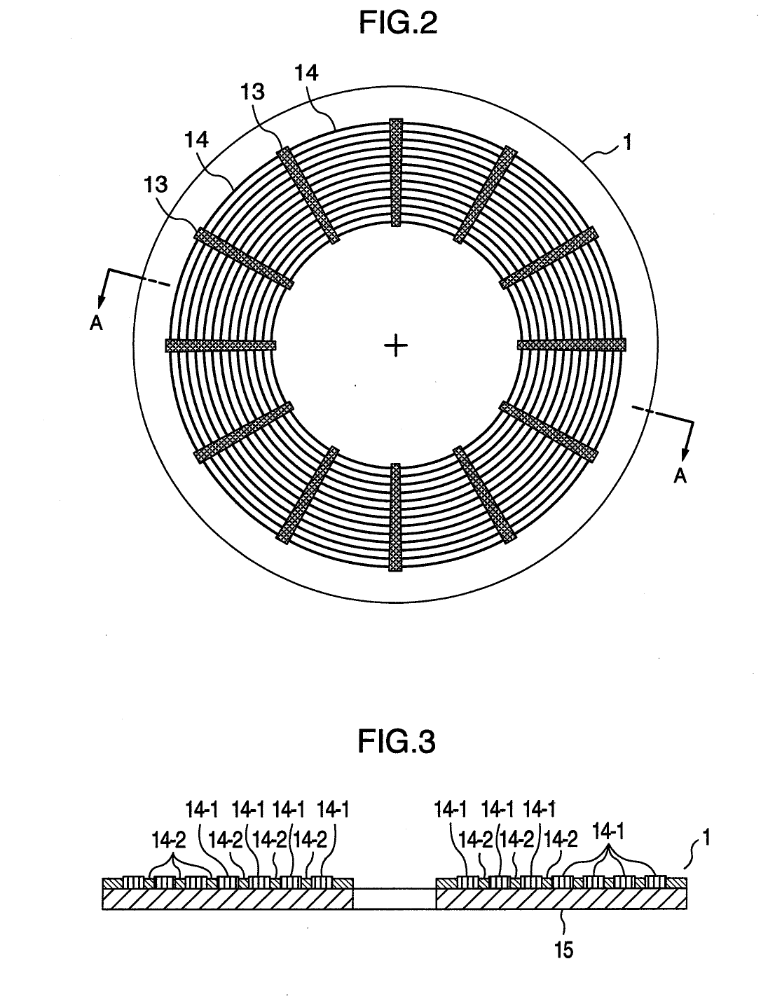

The DTM type disk 1 as viewed from above is illustrated in FIG. 2. The DTM type disk 1 includes an equidistant-pitch arrangement of alternate servo-region 13 recorded with information for detection of positions on the DTM disk 1 and data region 14 for recording and reproduction of data. The servo-information recorded on the servo-region 13 is read by the magnetic head 3 in FIG. 1 and decoded by the servo-decoding unit 8 for conversion into a position signal 103 so that the position of the magnetic head 3 in relation to the DTM type disk 1 may be detected.

Illustrated in FIG. 3 is the DTM type disk 1 sectioned on line A-A in FIG. 2. As shown in FIG. 3, the data region 14 has on a substrate 15 an concentric arrangement of alternate track 14-1 having its surface formed with a magnetic film adapted to hold data and groove 14-2 devoid of magnetic film adapted to magnetically separate adjacent tracks 14-1. In the example of FIG. 3, the groove 14-2 made of a non-magnetic material is filled having substantially the same height as that of the track 14-1 in consideration of the floating characteristics of the magnetic head 3.

Turing to FIG. 1, the DTM type disk 1 is fixedly mounted to the spindle 2 and the spindle 2 rotates at a constant revolution speed during recording/reproduction of data. The magnetic head 3 for recording and reproducing data to and from the DTM type disk 1 is fixedly mounted to the fine-movement actuator 5 through the medium of the suspension 4. The rough-movement stage 6 moves the fine-movement actuator 5 either to move the magnetic head 3 to an arbitrary radial position on the DTM type disk 1 or to retreat the magnetic head 3 from the surface of DTM type disk 1, thus performing rough-positioning of the magnetic head 3.

The fine-movement actuator 5 is driven in accordance with a sum signal 107 obtained by adding feed-forward data 100 outputted from the feed-forward drive unit 9 (FF data in FIG. 1) to servo-data 101 outputted from the servo-drive unit 10 by means of an adder 21 in order to position the magnetic head 3 on an arbitrary track 14-1 of DTM type disk 1. The spindle 2, fine-movement actuator 5 and rough-movement stage 6 are fixed to the surface plate 7 so as to be immune to external vibrations.

The servo-decoding unit 8 decodes servo information 102 read by the magnetic head 3 (recorded on the servo region 13) and converts it into a position signal 103 indicative of a position of magnetic head 3 in relation to the DTM type disk 1. A subtraction circuit 20 calculates a difference signal 105 between a target position signal 104 outputted from the control unit 11 and the position signal 103 decoded by the servo-decoding unit. By reducing the difference signal 105, the servo-drive unit 10 responsive to a signal 114 from the control unit 11 calculates, servo-data 101 necessary for the fine-movement actuator 5 to be so driven as to position the magnetic head 3 on a target track 14-1 and outputs the servo-data 101.

The feed-forward drive unit 9 includes a positioning error of repeatable runout operation section 9-1 (indicated by RRO operation section in FIG. 1), a feed-forward operation section 9-2 (indicated by FF data operation section in FIG. 1) and a feed-forward memory 9-3 (indicated by FF data memory in FIG. 1).

The positioning error of repeatable runout operation section 9-1 extracts from the position signal 103 delivered out of the servo-decoding unit 8 a component repeatable runout and outputs it as a positioning error of repeatable runout signal 106.

Upon feed-forward control initialization, the feed-forward data operation section 9-2 calculates from the positioning error of repeatable runout signal 106 delivered out of the positioning error of repeatable runout operation section 9-1 an initial value of feed-forward data for one period and stores it in the feed-forward data memory 9-3.

Then, during learning of feed-forward control, the feed-forward data operation section 9-2 recalculates, from the positioning error of repeatable runout signal 106 delivered out of the positioning error of repeatable runout operation section 9-1 and the feed-forward data 100 delivered out of the feed-forward data memory 9-3 as well, feed-forward data 100 and updates the value of feed-forward data memory 9-3.

The feed-forward data memory 9-3 outputs feed-forward data in synchronism with the rotation of spindle 2 to control the fine-movement actuator 5 in feed-forward fashion.

In the present invention, the feed-forward drive unit 9 also represents a pattern drive unit. More particularly, during idling, the feed-forward data operation section 9-2 determines, from the positioning error of repeatable runout signal 106 delivered out of the positioning error of repeatable runout operation section 9-1, an idling drive pattern and a drive interval and stores them in the feed-forward data memory 9-3 and the stored data is then outputted as feed-forward data in synchronism with the rotation of spindle 2, thereby carrying out pattern drive at the time of idling.

The control unit 11 controls operations of the spindle 2, the fine-movement actuator 5, the rough-movement stage 6, the feed-forward drive unit 9 and the servo-drive unit 10 on the basis of the signals 110, 111, 112, 113 and 114, respectively, and besides performs the comprehensive control of the whole apparatus, these operations having, however, no direct relation to the present invention and being not described herein.

The evaluation unit 12 responsive to a signal 115 from the control unit 11 confirms the status that the position control of magnetic head 3 is put in execution on the basis of the feed-forward data 100 and the servo-data 101 and thereafter, the magnetic head 3 records an evaluation pattern (specified pattern) on the DTM type disk 1 and on the basis of a read signal from the disk, the assessment unit assesses the magnetic recording characteristics.

The present apparatus having its overall construction as shown in FIG. 1 is constructed as described previously, including the function of head position control apparatus and the function of magnetic recording evaluation apparatus.

Further, in a head position control method according to this invention, a control method as below will be carried out with the help of the above construction.

Then, the positioning error of repeatable runout operation section 9-1 detects a positioning error of repeatable runout at a time point of starting learning the feed-forward control on the midway of the control initiation sequence under the condition that the servo-drive is not put in execution and the feed-forward data operation section 9-2 determines an idling drive pattern and a drive interval on the basis of the value of detected positioning error of repeatable runout signal 106

The thus determined drive pattern is stored in the feed-forward data memory 9-3 and is outputted as feed-forward data synchronously with the rotation of spindle 2, performing idling of the fine-movement actuator 5.

By resuming the control initiation sequence after the idling has ended, the leaning of feed-forward control can be carried out under the condition that variations in characteristics of fine-movement actuator due to heat generation or the like can be made stable and positioning errors can be reduced to enable the magnetic head 3 to follow the track 14-1 thereon with high accuracies.

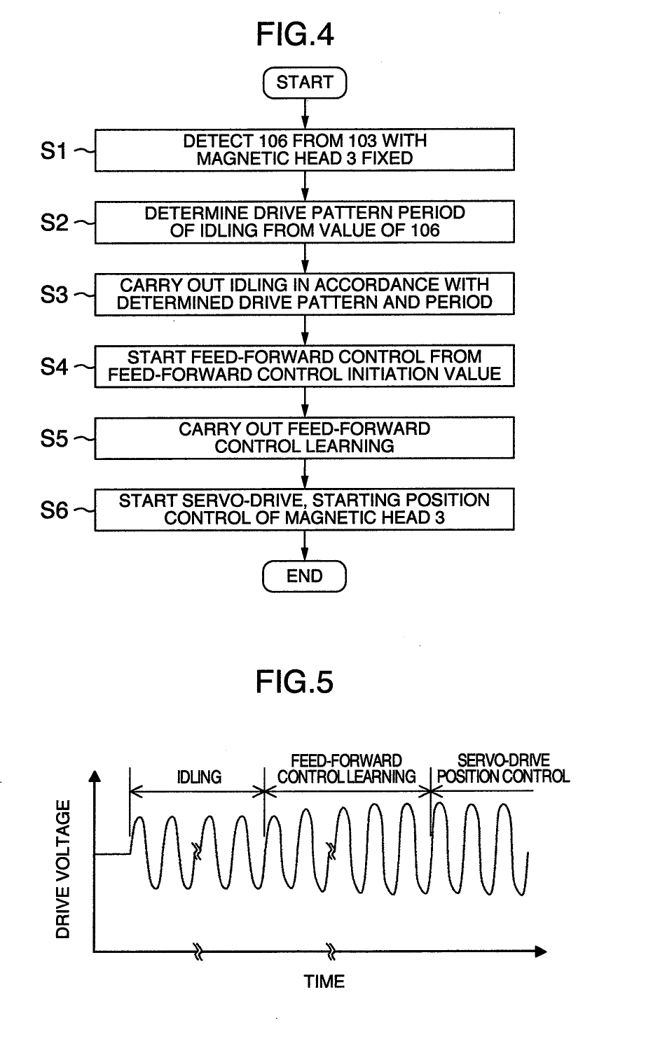

Illustrated in FIG. 4 is an example of procedures of the control initiation sequence added with the idling operation according to the invention. Steps are designated by S1 to S6. Firstly, a positioning error of repeatable runout signal 106 is detected from a position signal 103 while the magnetic head 3 is held in place (step S1) and on the basis of a value of positioning error of repeatable runout signal 106, a drive pattern and a drive interval of idling are determined (step S2).

The thus determined drive pattern is outputted for the predetermined drive interval to perform idling of the fine-movement actuator 5 (step S3). With the idling ended, an initial value of feed-forward control is calculated on the basis of the value of positioning error of repeatable runout signal 106 detected in the step S1 and feed-forward control of the fine-movement actuator 5 is started (step S4).

A positioning error of repeatable runout signal 106 under the feed-forward control status is detected and the feed-forward control learning is executed so that the detected value may decrease (step S5). After the feed-forward control learning has ended, a servo-drive is started and control of positioning of the magnetic head 3 on the track 14-1 is executed (step S6). To add, it is preferable that after start of the idling in step S3, drive of the fine-movement actuator 5 will not be stopped but will be proceeded with continuously for the purpose of making the characteristics stable. An example of a drive waveform for idling in the invention is illustrated in FIG. 5. As shown in FIG. 5, idling is first executed, learning of feed-forward control is subsequently performed and thereafter, servo-drive positioning control is carried out. In this example, the drive pattern is used for the feed-forward control initial value.

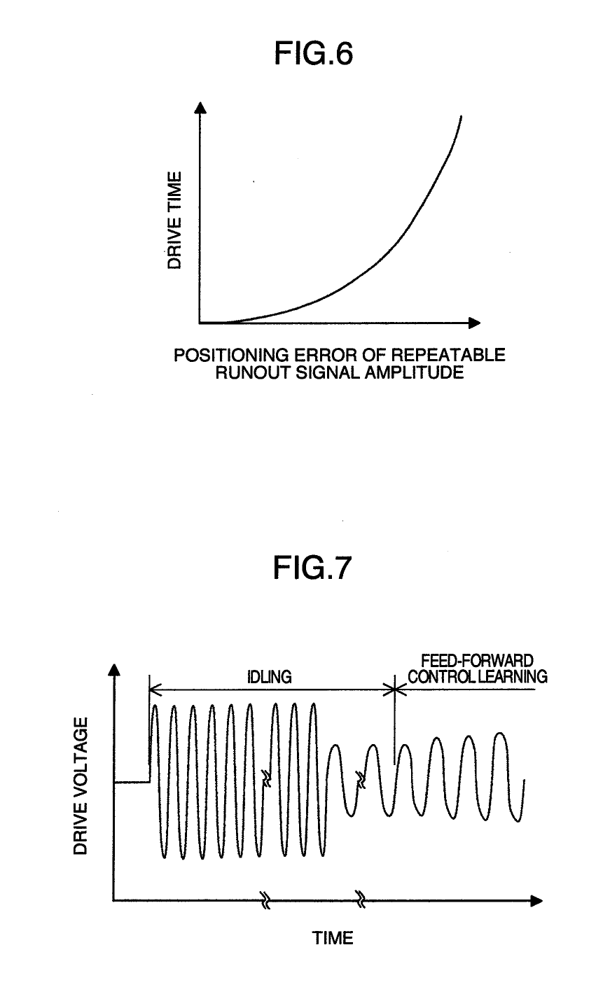

Referring to FIG. 6, an example of the relation between the amplitude and the drive interval of positioning error of repeatable runout signal 106 will be described. When the frequency is constant, heat generated in the fine-movement actuator 5 is considered to be proportional to the square of the drive current, that is, the amplitude of positioning error of repeatable runout signal 106. Then, since the feed-forward control initial value is substantially a rotation primary component and has a substantially constant frequency, the drive time is based on a value proportional to square of the amplitude of positioning error of repeatable runout signal 106. By using the drive pattern of idling for the feed-forward control initial value in this manner, smooth shift to the feed-forward control learning can be done while keeping the heat generation status constant and the accuracy of feed-forward control learning can be improved.

Further, by making the amplitude of idling drive pattern larger than the feed-forward control initial value or making the frequency higher, heat generation in the fine-movement actuator 5 can be accelerated and the drive interval can be shortened. In this case, by lowering the amplitude and frequency of drive pattern to those of the feed-forward control initial value in the latter half of idling, smooth shift to the feed-forward control learning can be done.

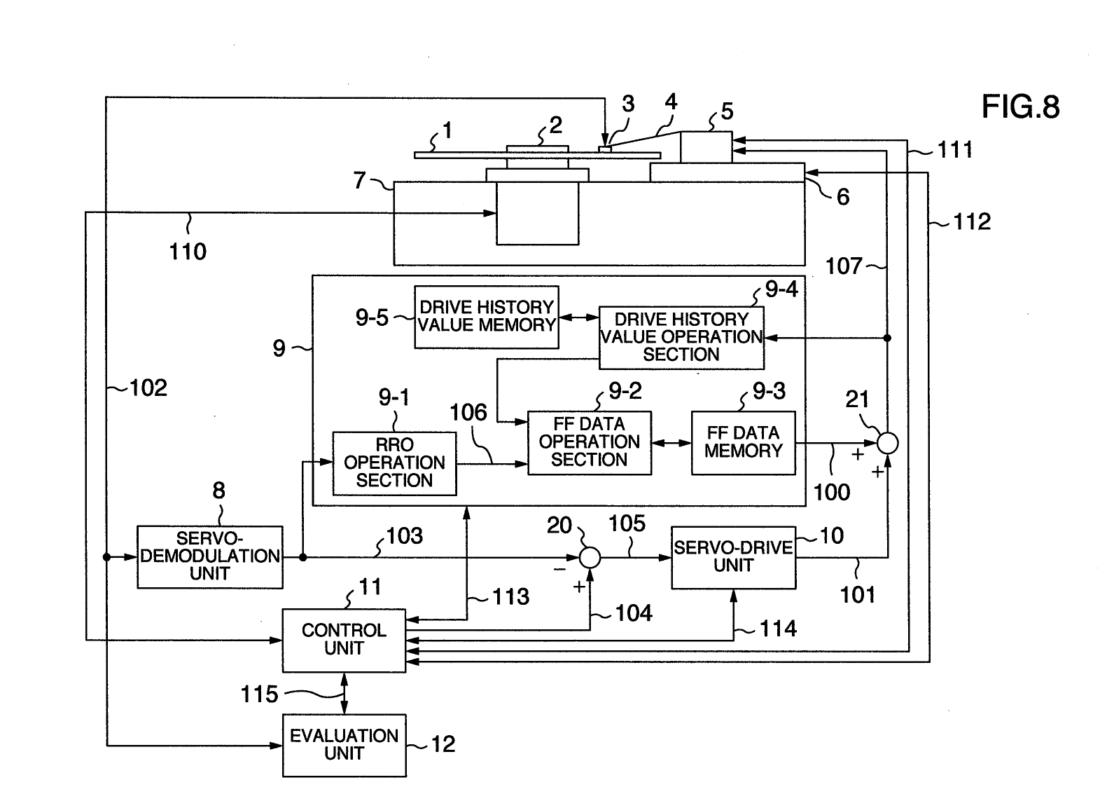

Turning now to FIG. 8, the overall construction of another embodiment of the present apparatus is illustrated. The basic construction is similar to that in FIG. 1 but the feed-forward drive unit 9 further includes a drive history value operation section 9-4 and a drive history value memory 9-5.

The drive history value operation section 9-4 calculates from the drive history of fine-movement actuator 5 a drive history value which in turn is stored along with an update time in the drive history value memory 9-5. When a new drive comes up, the drive history value till then is updated according to the drive time, drive pattern and drive interval. During the idling time, a drive history value and an update time are read out of the drive history value memory 9-5 to calculate a drive history value at present and the drive pattern and drive interval are changed in accordance with the calculated value.

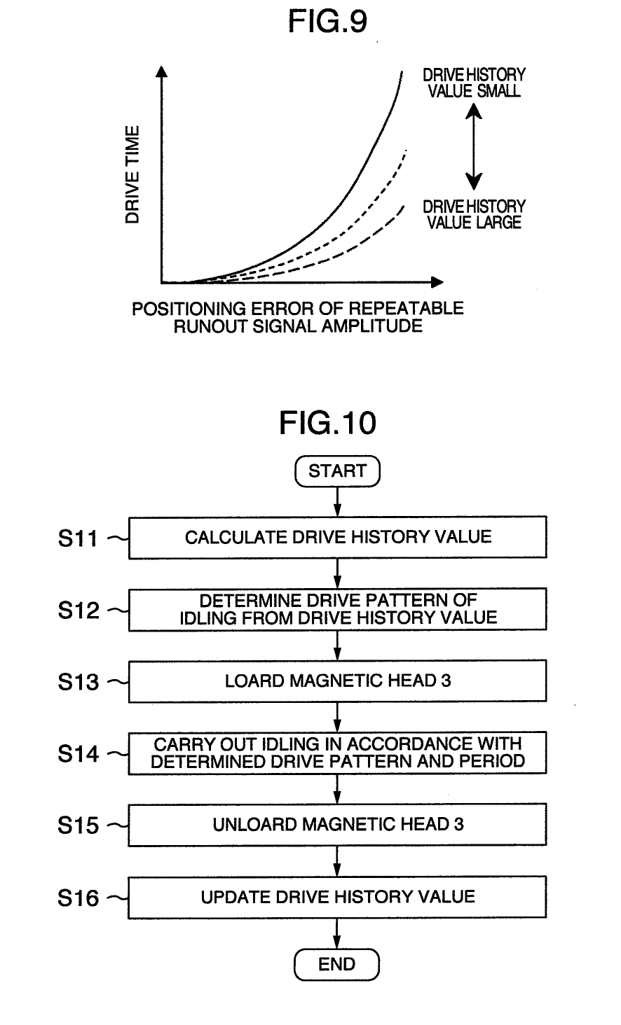

Specifically, as shown in an example of FIG. 9, for instance, the drive time is so set as to be prolonged for a small drive history value but is so set as to be shortened for a large drive history value. The amplitude and frequency of drive pattern can be changed in a similar way. By determining the drive pattern and drive interval of idling in consideration of the drive history of fine-movement actuator, the feed-forward control learning can be carried out under the condition that the characteristics of fine-movement actuator 5 can be made more stable.

The present apparatus having its overall construction as shown in FIG. 8 is constructed as described previously, including the function of head position control device and the function of magnetic recording evaluation apparatus.

Further, in another head position control method according to this invention, a control method as below will be carried out with the help of the above construction.

Generally, the whole of apparatus is cooled immediately after starting of the apparatus and so, in order to perform highly accurate evaluation, it is desirable that idling of the whole apparatus be performed to warm up individual parts. In such a case, during the apparatus idling, idling of the fine-movement actuator 5 can also be executed concurrently.

An example of procedures when the idling operation of fine-movement actuator 5 is carried out during idling of the FIG. 8 apparatus is shown in a flowchart of FIG. 10. Steps are designated by S11 to S16. Firstly, a drive history value is calculated (step S11) and on the basis of the drive history value, a drive pattern and a drive interval of idling are determined (step S12). The magnetic head 3 is loaded in a free fashion (step S13) and idling of the actuator is carried out (step S14). With the idling ended, the magnetic head 3 is unloaded (step S15) and the drive history value is updated (step S16).

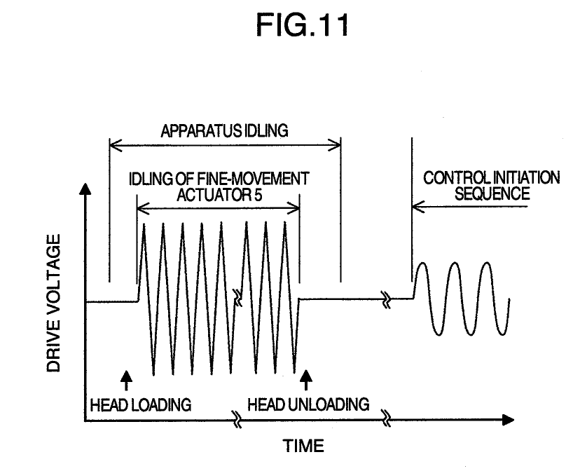

FIG. 11 shows an example of a drive waveform when idling operation of the fine-movement actuator 5 is carried out during idling of the FIG. 8 apparatus. Since the drive waveform is a triangular waveform, the drive current of fine-movement actuator 5 can be substantially constant and heating can further be accelerated.

Even when the idling is done before the control initiation sequence, idling can be executed again during control initiation sequence, so that idling can be done at the two time intervals to further improve the accuracy of feed-forward control learning.

The heat generation status in the fine-movement actuator 5 is operated to provide drive history values which in turn are stored in the memory but individual drive patterns, drive intervals and drive times may be stored as a drive history in the memory and a heat generation status of fine-movement actuator 5 may be calculated from the stored drive history.

In the foregoing embodiments, the drive pattern of idling is repetitively generated in synchronism with the rotation of spindle 2 but the periodical pattern synchronous with the rotation is not particularly necessary and so long as a drive pattern is for causing current to flow through the fine-movement actuator 5, the pattern may be employed while the amplitude and frequency being made variable or the pattern which is non-periodic and random may not matter.

Alternatively, in the foregoing embodiments, all or part of the servo-decoding unit 8, feed-forward drive unit 9, servo-drive unit 10 and control unit 11 may be constructed by a microprocessor in combination with an AD converter or a DA converter.

Further, the present invention is applicable not only to the DTM type disk only but also to a bit-patterned media (BPM) type disk having a non-magnetic region between adjacent tracks similarly.

The present invention is for performing highly accurate positioning indispensable for the magnetic disk apparatus of high density and is expected to be adopted widely as a technique indispensable for the high-density magnetic disk apparatus.

It should be further understood by those skilled in the art that although the foregoing description has been made on embodiments of the invention, the invention is not limited thereto and various changes and modifications may be made without departing from the spirit of the invention and the scope of the appended claims.

1. A head position control apparatus comprising:
a rotary drive mechanism for rotating a magnetic recording medium formed in advance with servo-patterns;
a magnetic head for recording and reproducing a signal to and from said magnetic recording medium;
an actuator capable of moving said head on said magnetic recording medium in at least radial direction thereof;
a servo-decoding unit for detecting from a servo-pattern read signal of said magnetic head a relative position of said magnetic head to said magnetic recording medium;
a servo-drive unit responsive to the position signal from said servo-decoding unit to generate a servo-drive signal adapted to control positioning of said actuator;
a pattern drive unit for generating a pattern drive signal adapted to drive said actuator in accordance with a predetermined drive pattern; and
a control unit for controlling operation of the respective components, wherein
said control unit provides an idling interval during at least one of a period preceding a control initiation sequence for said servo-drive unit to start controlling said actuator and a period being on the midway of the control initiation sequence;
said pattern drive unit generates a pattern drive signal adapted to drive said actuator in accordance with the predetermined drive pattern during the idling interval;
said servo drive unit stops the control initiation sequence during the idling interval and starts or resumes the control initiation sequence after the idling interval has ended; and
said actuator responds to a pattern drive signal from said pattern drive unit and a servo-drive signal from said servo-drive unit to control the position of said magnetic head.

2. A head position control apparatus according to claim 1 further comprising a rotation synchronous signal detection unit for detecting from the position signal delivered out of the servo-decoding unit a rotation synchronous signal in synchronism with the rotation of the rotary drive mechanism, wherein
said pattern drive unit determines a length of the idling interval and a drive pattern on the basis of the rotation synchronous signal from said rotation synchronous signal detection unit; and
said control unit controls said pattern drive unit and idling operation of said servo-drive unit on the basis of the idling interval length determined by said pattern drive unit.

3. A head position control apparatus according to claim 1 further comprising a drive history operation unit for calculating a drive history signal of said actuator from the drive signal thereof, wherein
said pattern drive unit determines a length of the idling interval and a drive pattern on the basis of the drive history signal from said drive history operation unit, and
said control unit controls said pattern drive unit and idling operation of said servo-drive unit on the basis of the idling interval length determined by said pattern drive unit.

4. A head position control apparatus according to claim 1 wherein an operation for learning the feed-forward control is included in the control initiation sequence.

5. A position control apparatus according to claim 1, wherein said actuator is a piezo-actuator.

6. A magnetic recording assessment apparatus comprising:
a rotary drive mechanism for rotating a magnetic recording medium formed in advance with servo-patterns;
a magnetic head for recording and reproducing a signal to and from said magnetic recording medium;
an actuator capable of moving said magnetic head on said magnetic recording medium in at least radial direction thereof;
a servo-decoding unit for detecting from a servo-pattern read signal of said magnetic head a relative position of said magnetic head to said magnetic recording medium;
a servo-drive unit responsive to the position signal from said servo-decoding unit to generate a servo-drive signal adapted to control positioning of said actuator;
a pattern drive unit for generating a pattern drive signal adapted to drive said actuator in accordance with a predetermined drive pattern;
a control unit for controlling operation of the respective components; and
an evaluation unit for recording a specified pattern on said magnetic recording medium with the help of said magnetic head and for evaluating magnetic recording characteristics from a reproduction signal of the specified pattern, wherein
said control unit provides an idling interval during at least one of a period preceding a control initiation sequence for said servo-drive unit to start controlling said actuator and a period being on the midway of the control initiation sequence;
said pattern drive unit generates a pattern drive signal adapted to drive said actuator in accordance with the predetermined drive pattern during the idling interval;
said servo drive unit stops the control initiation sequence during the idling interval and starts or resumes the control initiation sequence after the idling interval has ended;
said actuator responds to a pattern drive signal from said pattern drive unit and a servo-drive signal from said servo-drive unit to control the position of said magnetic head; and
said evaluation unit records the specified pattern on said magnetic recording medium under the status that the magnetic head position control is put in execution and evaluates the magnetic recording characteristics from the reproduction signal of the specified pattern.

7. A magnetic recording evaluation apparatus according to claim 6 further comprising a rotation synchronous signal detection unit for detecting from the position signal delivered out of said servo-decoding unit a rotation synchronous signal in synchronism with the rotation of said rotary drive mechanism, wherein
said pattern drive unit determines a length of the idling interval and a drive pattern on the basis of the rotation synchronous signal from said rotation synchronous signal detection unit; and
said control unit controls said pattern drive unit and idling operation of said servo-drive unit on the basis of the idling interval length determined by said pattern drive unit.

8. A magnetic recording assessment apparatus according to claim 6 further comprising a drive history operation unit for calculating a drive history signal of said actuator from the drive signal thereof, wherein
said pattern drive unit determines a length of the idling interval and a drive pattern on the basis of the drive history signal from said drive history operation unit; and
said control unit controls said pattern drive unit and idling operation of said servo-drive unit on the basis of the idling interval length determined by said pattern drive unit.

9. A magnetic recording evaluation apparatus according to claim 6, wherein an operation for learning the feed-forward control is included in the control initiation sequence.

10. A magnetic recording assessment apparatus according to claim 6, wherein said actuator is a piezo-actuator.

11. A head position control method incorporating a rotary drive mechanism for rotating a magnetic recording medium formed in advance with servo-patterns, a magnetic head for recording and reproducing a signal to and from said magnetic recording medium, an actuator capable of moving said magnetic head on said magnetic recording medium in at least radial direction thereof, a servo-decoding unit for detecting from a servo-pattern read signal of said magnetic head a relative position of said magnetic head to said magnetic recording medium, a servo-drive unit responsive to the position signal from said servo-decoding unit to generate a servo-drive signal adapted to control positioning of said actuator, a pattern drive unit for generating a pattern drive signal adapted to drive said actuator in accordance with a predetermined drive pattern, and a control unit for controlling operation of the respective components, said method comprising the steps of:
driving said actuator in accordance with the predetermined drive pattern;
subsequently carrying out operation for learning the feed-forward control; and
thereafter, causing said servo-drive unit to start the operation for positioning said magnetic head.

12. A head position control method incorporating a rotary drive mechanism for rotating a magnetic recording medium formed in advance with servo-patterns, a magnetic head for recording and reproducing a signal to and from said magnetic recording medium, a piezo-actuator capable of moving said magnetic head on said magnetic recording medium in at least radial direction thereof, said method comprising the step of:
going through a process of heat generation due to idling of said piezo-actuator before starting the magnetic head positioning operation and thereafter, starting the magnetic head positioning operation.

13. A head position control method according to claim 12, wherein the idling pattern and idling interval of said piezo-actuator are determined in accordance with a positioning error of repeatable runout signal.

14. A head position control method according to claim 13, wherein the idling pattern and idling interval of said piezo-actuator are changeable in accordance with a drive history.
